(19) United States
(12) Patent Application Publication
(10) Pub. No.: US 2025/0005660 A1
(43) Pub. Date: Jan. 2, 2025

(54) SYSTEMS AND METHODS FOR PROVIDING CREDIT CLASSIFICATION PREDICTIONS

(71) Applicant: JPMORGAN CHASE BANK, N.A., New York, NY (US)

(72) Inventor: Howard SPECTOR, Street, MD (US)

(21) Appl. No.: 18/757,117

(22) Filed: Jun. 27, 2024

Related U.S. Application Data
(60) Provisional application No. 63/510,795, filed on Jun. 28, 2023.

(51) Int. Cl. G06Q 40/03

(52) U.S. Cl. CPC G06Q 40/03

(57) ABSTRACT

A method may include: a credit classification computer program (1) ingesting historical data for prior credit applications; (2) separating the historical data into a plurality of categories; (3) encrypting the historical data in each category; (4) training a machine learning model for each category with the encrypted historical data for that category; (5) receiving, from a credit applicant computer program, credit applicant information; (6) separating the credit applicant information into the plurality of categories; (7) predicting, using the plurality of machine learning models for each category, a credit classification using the credit application information for that category; (8) aggregating the plurality of credit classifications into a final credit classification; and (9) outputting the final credit classification to a downstream system, wherein the downstream system is configured to execute an action in response to the final credit classification.

### RELATED APPLICATIONS

This application claims priority to, and the benefit of, U.S. Provisional Patent Application Ser. No. 63/510,795, filed Jun. 28, 2023, the disclosure of which is hereby incorporated, by reference, in its entirety.

### BACKGROUND

### 1. Field of the Invention

Embodiments generally relate to systems and methods for providing credit classification predictions.

### 2. Description of the Related Art

A credit profile for use with/by institutions that issue credit products, such as loans, credit cards, mortgages, lines of credit, etc., can be difficult to establish. Credit applicants that are foreigners with respect to an issuing organization may have no domestic credit profile. Additionally, domestic credit applicants may not have a robust credit history, or any credit history, if they have not previously needed or desired a credit product. This not only affects a credit applicant's ability to receive a credit product, but also impacts the price of the credit product (e.g., in terms of an interest rate, initiation fees, etc.) that may be offered to a credit applicant. This is due to the uncertainty surrounding the applicant's credit history, since issuing organizations weigh risks of default in decisioning the extension and terms of a credit product to an applicant and an applicant without a credit profile built on a credit history is often deemed a high default risk, even if only due to a lack of historical credit information.

### SUMMARY

Systems and methods for providing credit classification predictions are disclosed. In one embodiment, a method may include: (1) ingesting, by a credit classification computer program executed by an electronic device, historical data for prior credit applications; (2) separating, by the credit classification computer program, the historical data into a plurality of categories; (3) encrypting, by the credit classification computer program, the historical data in each category; (4) training, by the credit classification computer program, a machine learning model for each category with the encrypted historical data for that category; (5) receiving, by the credit classification computer program and from a credit applicant computer program, credit applicant information; (6) separating, by the credit classification computer program, the credit applicant information into the plurality of categories; (7) predicting, by the credit classification computer program and using the plurality of machine learning models for each category, a credit classification using the credit application information for that category; (8) aggregating, by the credit classification computer program, the plurality of credit classifications into a final credit classification; and (9) outputting, by the credit classification computer program, the final credit classification to a downstream system, wherein the downstream system may be configured to execute an action in response to the final credit classification.

In one embodiment, the plurality of categories comprise a plurality of income, expenses, age, employment status, employment years, employment type, home ownership status home location, marital status, family status, liability information, and asset ownership.

In one embodiment, the historical data in each category may be encrypted using homomorphic encryption.

In one embodiment, the plurality of credit classifications and the final credit classification may be selected from the group consisting of fair, good, very good, and excellent.

In one embodiment, the step of aggregating, by the credit classification computer program, the plurality of credit classifications into the final credit classification may include: assigning, by the credit classification program, a weight to each of the plurality of credit classifications; and combining, by the credit classification computer program, the plurality of credit classifications according to their weights.

In one embodiment, the weights may be predicted using a second machine learning model.

In one embodiment, the method may also include encrypting, by the credit classification computer program, the credit application in each category using homomorphic encryption.

According to another embodiment, a system may include: a database comprising historical data for prior credit applications; an electronic device executing a credit classification computer program; a user electronic device executing a credit applicant computer program; and a downstream system. The credit classification computer program ingests the historical data for prior credit applications; separates the historical data into a plurality of categories; encrypts the historical data in each category; trains a machine learning model for each category with the encrypted historical data for that category; receives credit applicant information from the credit applicant computer program; separates the credit applicant information into the plurality of categories; predicts, using the plurality of machine learning models for each category, a credit classification using the credit application information for that category; aggregates the plurality of credit classifications into a final credit classification; and outputs the final credit classification to the downstream system. The downstream system executes an action in response to the final credit classification.

In one embodiment, the plurality of categories comprise a plurality of income, expenses, age, employment status, employment years, employment type, home ownership status home location, marital status, family status, liability information, and asset ownership.

In one embodiment, the historical data in each category may be encrypted using homomorphic encryption.

In one embodiment, the plurality of credit classifications and the final credit classification may be selected from the group consisting of fair, good, very good, and excellent.

In one embodiment, the credit classification computer program aggregates the plurality of credit classifications into a final credit classification by assigning a weight to each of the plurality of credit classifications; and by combining the plurality of credit classifications according to their weights.

In one embodiment, the weights may be predicted using a second machine learning model.

In one embodiment, the credit classification computer program encrypts the credit application in each category using homomorphic encryption.

According to another embodiment, a non-transitory computer readable storage medium may include instructions stored thereon, which when read and executed by one or more computer processors, cause the one or more computer processors to perform steps comprising: ingesting historical data for prior credit applications; separating the historical data into a plurality of categories; encrypting the historical data in each category; training a machine learning model for each category with the encrypted historical data for that category; receiving, from a credit applicant computer program, credit applicant information; separating the credit applicant information into the plurality of categories; predicting, and using the plurality of machine learning models for each category, a credit classification using the credit application information for that category; aggregating the plurality of credit classifications into a final credit classification; and outputting the final credit classification to a downstream system.

In one embodiment, the plurality of categories comprise a plurality of income, expenses, age, employment status, employment years, employment type, home ownership status home location, marital status, family status, liability information, and asset ownership.

In one embodiment, the historical data in each category may be encrypted using homomorphic encryption.

In one embodiment, the plurality of credit classifications and the final credit classification may be selected from the group consisting of fair, good, very good, and excellent.

In one embodiment, aggregating the plurality of credit classifications into the final credit classification may include: assigning a weight to each of the plurality of credit classifications; and combining the plurality of credit classifications according to their weights; wherein the weights may be predicted using a second machine learning model.

In one embodiment, the non-transitory computer readable storage medium may also include instructions stored thereon, which when read and executed by one or more computer processors, cause the one or more computer processors to perform steps comprising: encrypting the credit application in each category using homomorphic encryption.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for providing credit classification predictions according to an embodiment.

FIG. 2 depicts a method for providing credit classification predictions according to an embodiment.

FIG. 3 is a block diagram of a computing device for implementing certain embodiments of the present disclosure.

### DETAILED DESCRIPTION

Embodiments generally relate to systems and methods for providing credit classification predictions.

Embodiments may facilitate decisioning for credit products where an applicant may have no or little historical credit data. Credit applicants may be domestic applicants or foreign applicants with respect to the credit product issuing organization. Data collected by an issuing organization may be used to train one or more machine learning models. The trained machine learning models may be used in a decisioning process to predict creditworthiness of a credit applicant.

In accordance with embodiments, a backend technology infrastructure of an issuing organization may provide a platform for credit applicants. The platform may include an interface (e.g., a graphical user interface) that may accept input from a credit applicant that is a user of the platform/interface. The interface may take any suitable form, such as a web page, a mobile application interface, etc. The interface may prompt the credit applicant for input applicant data. Applicant data may include personal information such as employment status, employer, years employed, home ownership status, other asset ownership status (e.g., car ownership, etc.), compensation level, marital status, parental status, etc. Other input may include a foreign credit product agreement history, a history of credit product statements, a history of purchases made with a foreign credit product (that shows continued availability of a credit product for use), etc. A credit classification platform may receive applicant data from a provided interface and store and associate the applicant data with a corresponding (i.e., a providing) credit applicant.

A credit classification platform may further provide a machine learning engine including a machine learning algorithm and a machine learning model. The machine learning algorithm may be used to train the associated machine learning model on historical data that may be retained by the issuing organization. The historical data may include data that is categorically the same or similar to data received as input from credit applicants. That is, the issuing organization may retain (e.g., from current and/or former customers) personal data, spending habits, etc. Due to the nature of an issuing organization's business, it may have large amounts of such data on hand. Moreover, the data may be easily anonymized for use with a credit classification platform.

Historical data retained by an issuing organization may include data from across the organization such as customer deposits, investments, auto loans and types of vehicles financed, home data and home mortgage amounts, etc. Further, if the organization has foreign locations, subsidiaries, affiliates, etc., similar data from these locations/organizations may be used. Third-party data, such as data from partner organizations and that can be related back to a customer, may also be employed as historical data. This includes data from retailers, airlines, hospitality organizations, etc. Merchant data and investment data, if available, may also be utilized as historic data.

Historical data retained by an issuing organization may be anonymized and may be used to classify related (but anonymous) individuals according to levels of creditworthiness. That is, data related to an anonymous individual may be categorized as not credit worthy, credit worthy, highly credit worthy, etc. Any suitable scale and/or increments may be used as various creditworthiness classifications in which to group historical data and a corresponding anonymized user. For instance, a common credit score scheme that ranges from, e.g., 250-850 may be used, where a score falling in the range of 250-600 is classified as poor, a score falling in the range of 601-659 is classified as fair, a score falling in the range of 660-699 is classified as good, a score falling in the range of 700-759 is classified as very good, and a score falling in the range of 760-850 is classified as excellent.

An issuing organization's anonymized and classified historical data may be provided to a machine learning algorithm which may generate and train one or more machine learning model to predict a creditworthiness classification when the model is exposed to similar data received as input from a credit applicant. That is, a machine learning algorithm may fit any suitable historical data to machine learning models to produce models that provide a creditworthiness prediction based on particular input. A portion of the historical data may be used as validation data, and the machine learning model may be tuned until acceptable levels of confidence are reached. Other data that may be used in machine learning model training includes an amount of funds associated with an individual, service account data, such as data from a merchant service account where individuals maintain accounts for receiving payments for business and other ventures, and any other financial data that may indicate an individual's credit worthiness, net worth, etc.

In one embodiment, a credit classification platform may use input from a third-party as further input to a credit decisioning process. For instance, an issuing organization may provide a third party with basic personal information details collected from a credit applicant. The third party may use the basic personal information, such as name, address, a government identification, etc., to run and perform an information gathering service with respect to the credit applicant in a foreign jurisdiction. Exemplary information gathering services include credit checks, background check, or other services that gather relevant information on the credit applicant. The gathered information from the third party may be returned to the issuing organization and may be used as additional input in the credit classification process.

In accordance with embodiments, when sending basic personal information to a third party, and when receiving return information (e.g., results from an information gathering service supplied by the third party), an encrypted and validated communication method may be used. For instance, a communication channel may be established with an encrypted handshake and the parties may be validated through the use of digital signatures with the transmitted data.

In accordance with embodiments, a homomorphic encryption scheme may also be used in order to secure and/or anonymize data with a credit classification platform. Homomorphic encryption is a form of encryption that allows data to be processed in encrypted form. That is, homomorphic encryption allows computations and analytics to be performed on encrypted data. The resultant output is also in encrypted form and, if decrypted, is identical to the results had the processing been done on the unencrypted form of the input data. Accordingly, homomorphic encryption allows sensitive data to be encrypted and processed without the data or the results of the processing being readable by humans. Homomorphic encryption utilizes public/private key cryptography. Data is encrypted with a public key but can only be decrypted with a corresponding private key. The results of processing encrypted data that is homomorphically encrypted may also be decrypted by the same private key that corresponds to the public key used to encrypt associated input data. Several types or levels of homomorphic encryption exist. These include: Partially Homomorphic Encryption (PHE), Somewhat Homomorphic Encryption (SHE), and Fully Homomorphic Encryption (FHE). PHE only allows selected mathematical functions to be performed on encrypted data. SHE allows a limited number of mathematical operations up to a certain complexity to be performed, for a limited number of times. FHE allows any kind of mathematical operation to be performed for an unlimited number of times.

Homomorphic encryption is, however, computationally expensive and slow. Thus, embodiments may separate the historical data into a plurality of categories before the historical data is encrypted and further processed.

In accordance with embodiments, information about a credit applicant may be gathered by a third party and may be encrypted and sent to an issuing organization. The issuing organization may also encrypt data collected directly from a credit applicant (e.g., via a platform interface) and may provide the encrypted data from the third party and the encrypted data collected directly from a credit applicant and provide both sets of encrypted data in an encrypted stream to machine learning models. The machine learning models may be configured to process the encrypted data and provide an encrypted result using homomorphic encryption techniques. The machine learning models may be configured to provide an encrypted output. The output may be decrypted by platform only after the prediction processing is complete, so that the data components used as input to the machine learning models remain anonymous and not human readable, but the predicted credit classification is available.

In accordance with embodiments, homomorphic encryption may also be used when data from third-party organizations submit financial data about an individual. For instance, institutions such as insurance firms, law firms, etc., may participate in a homomorphic encryption scheme in which an institution sends financial or other relevant data to a common or central hub. Encrypted data received at the common hub (which may be a datastore configured to be in operative communication with machine learning models and further configured for use of a homomorphic encryption scheme) may be exposed to a machine learning model and may contribute to generation of a credit classification prediction. In one embodiment, an application programming interface (API) may be used to submit or retrieve encrypted data to a common hub, or to a private platform.

In accordance with embodiments, historical data used to train a machine learning model may also be used in order to populate a visual interface and provide visual context for an employee user of an issuing organization. Model output may further be used in the visual interface. For instance, a visual interface may present a depiction of a plurality of nodes where each of the nodes represents an anonymous user that is represented in the historical data that is used to train a machine learning model of a credit classification platform, or a cluster of anonymous users associated with similar historic data. As mentioned above, each of the nodes (which represents an anonymized individual and that individual's associated data) may be assigned a creditworthiness classification. Each node may be color coded according to its assigned creditworthiness classification. For example, “poor” may be red, “fair” may be orange, “good” may be yellow, and excellent may be “green.”

Once a prediction is made based on a credit applicant's provided input to the platform, the credit applicant may be represented by a node on the visual interface. The credit applicant's node may also be color coded according to the class that the credit classification platform predicts for the applicant. This may allow an employee user of an issuing organization to efficiently visualize a credit applicant's credit status.

Moreover, a visual interface may be presented in a graph format. The graph format may include edges that connect the nodes based on relationships between the nodes, the edges may include properties that describe the relationship between two connected nodes. For example, an edge that connects two nodes may represent a similar occupation, a similar income status, a similar parental or familial status, etc. Depiction in this manner may provide an efficient visualization of factors (e.g., input data) that led to the particular predicted classification of a credit applicant. In one embodiment, a generative machine learning model may be used to build and update the graph data that is displayed via the visual interface. For instance, historic data and prediction data may be provided as input to a Graph Convolutional Network (GCN) model, a Graph Attention Network (GAT) model, etc.

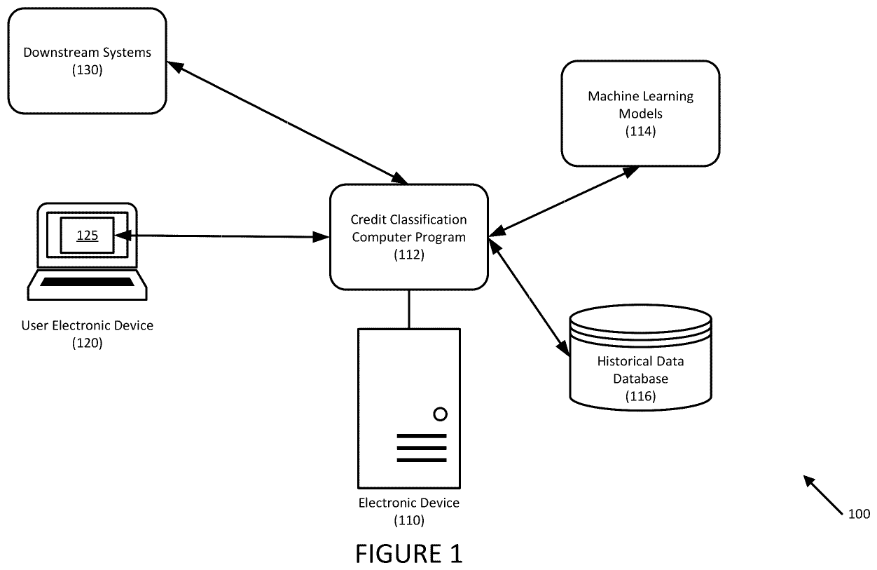

FIG. 1 depicts a system for providing credit classification predictions according to an embodiment. System 100 may include electronic device 110, which may be a server (e.g., physical and/or cloud-based), computers (e.g., workstations, desktops, etc.). Electronic device 110 may execute credit classification computer program 112, which may predict a credit classification for a user that may have little or no credit history using machine learning models 114.

Credit classification computer program 112 may access historical data in historical data database 116 and may encrypt the historical data before it is used to train machine learning models 114. For example, credit classification computer program 112 may encrypt the historical data using homomorphic encryption, which allows for the data to be manipulated in its encrypted state in order to reduce the risk of data exposure.

Credit classification computer program 112 may separate the historical data into a plurality of categories before the historical data is encrypted. Examples of categories may include income, expenses, age, employment status, employment years, employment type, home ownership status home location, marital status, family status, liability information, asset ownership, etc.

In another embodiment, the historical data may be separated and encrypted as it is ingested.

In one embodiment, the historical data may be augmented with credit data, such as credit scores, payment history, default history, etc. The credit data may also be encrypted.

Once separated, credit classification computer program 112 may encrypt the data in the categories.

Credit classification computer program 112 may use the encrypted historical data and the credit data to train category machine learning models 114. In one embodiment, each category may train a separate category machine learning model.

The category machine learning models may be trained to return a credit classification prediction, such as fair/good/very good/excellent, risk/no risk, high risk/medium risk/low risk, 1-10, A-F, etc. Any suitable classification scheme may be used as is necessary and/or desired.

In one embodiment, an aggregation machine learning model may be trained to predict weightings for the output of each category machine learning model. For example, the output of each category machine learning model may be assigned a weight that may be used when the classification predictions are aggregated.

A credit applicant may provide user data to credit classification computer program 112 using, for example, user electronic device 120 executing credit applicant computer program 125. User electronic device may be any suitable electronic device, including computers (e.g., desktops, laptops, notebooks, tablets, etc.), smart devices (e.g., smart watches, smart phones, etc.), Internet of Things (IoT) appliances, etc. Credit applicant computer program 125 may be an application, a browser, etc.

In one embodiment, credit applicants may also link their existing bank accounts (for example, using an aggregator), and credit classification computer program 112 or credit applicant computer program 125 may retrieve the credit applicant's spending and earning history.

In one embodiment, before providing user data to credit classification computer program 112, credit applicant computer program 125 may separate the user data into the categories, and may encrypt the credit applicant data using, for example, homomorphic encryption.

Downstream system 130 may receive the final credit classification prediction and may take an action. For example, downstream system may be a bank system (e.g., a credit decisioning system), a third-party system (e.g., a merchant system, etc.). Based on the final credit classification, downstream system may extend or not extend credit to the user.

In one embodiment, the machine learning models may be periodically updated or retrained using, for example, the final classification and post-classification credit data following the final classification (e.g., amount of credit extended, payment history, defaults, post-classification credit scores, etc.). The final classification may be fed back to train the machine learning model. This may also be used to predict a future credit applicant's ability to pay.

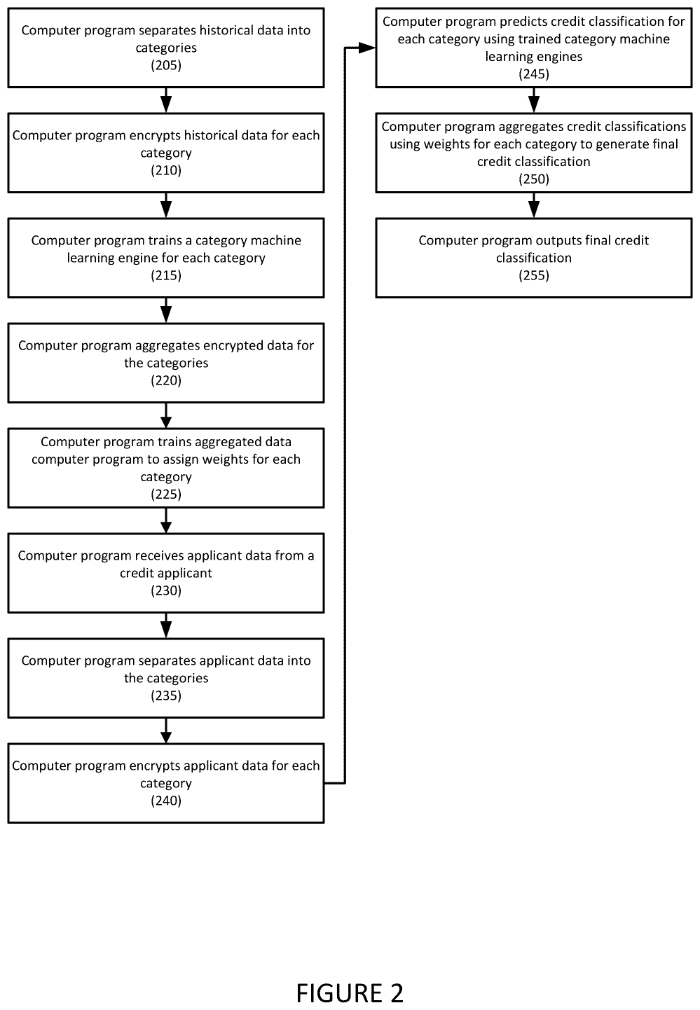

FIG. 2 depicts a method for providing credit classification predictions according to an embodiment.

In step 205, a computer program, such as a credit classification computer program, may ingest historical data and may separate the historical data into a plurality of categories. For example, the historical data may include income, expenses, age, employment status, employment years, employment type, home ownership status home location, marital status, family status, liability information, asset ownership, etc.

In one embodiment, the credit classification computer program may also receive credit data and may augment the historical data with the credit data.

In step 210, the credit classification computer program may encrypt the historical data for each category using, for example, homomorphic encryption.

In step 215, the credit classification computer program may train a category machine learning model for each category of historical data. The machine learning model may be trained to predict a credit classification, such as fair/good/very good/excellent, risk/no risk, high risk/medium risk/low risk, 1-10, A-F, etc. Any suitable classification scheme may be used as is necessary and/or desired.

In step 220, the credit classification computer program may aggregate the encrypted data for the categories. In one embodiment, the aggregation may leverage model chaining, where the output of one model is used as the input to another model. In one embodiment, the models may execute in a specific sequence.

In one embodiment, the initial input data may be used with the model output where needed. For example, the initial data may not be used by every model, but may be available as needed.

In step 225, the credit classification computer program may train an aggregated data computer program to assign a weight to the output of each category machine learning model.

In step 230, a credit applicant computer program on a credit applicant electronic device may receive credit applicant data from a credit applicant. The credit applicant data may be received as part of a credit application. For example, the credit applicant computer program may receive the credit applicant's income, expenses, age, employment status, employment years, employment type, home ownership status home location, marital status, family status, liability information, asset ownership, etc.

In step 235, the credit applicant computer program may separate the credit applicant data into the categories, and in step 240, may encrypt the data in the categories using, for example, homomorphic encryption.

In step 245, the credit classification computer program may use the category machine learning models to predict a credit classification for each category. The category machine learning models may output the credit classification predictions.

In step 250, the credit classification computer program may aggregate the credit classifications using the assigned weights for each category machine learning model to generate final credit classification. For example, the output of each of the category machine learning models may be combined into a final classification according to a weighting.

In another embodiment, the output of each of the category machine learning models may be provided to a machine learning engine that is trained to generate a final classification from the outputs of the category machine learning engines.

In step 255, the credit classification computer program may output the final credit classification and may provide it to one or more downstream systems. The downstream systems may use the final credit classification to decision the credit applicant's application.

The credit classification computer program may periodically update or retrain the machine learning model(s) using, for example, the final classification and post-classification credit data following the final classification (e.g., amount of credit extended, payment history, defaults, post-classification credit scores, etc.).

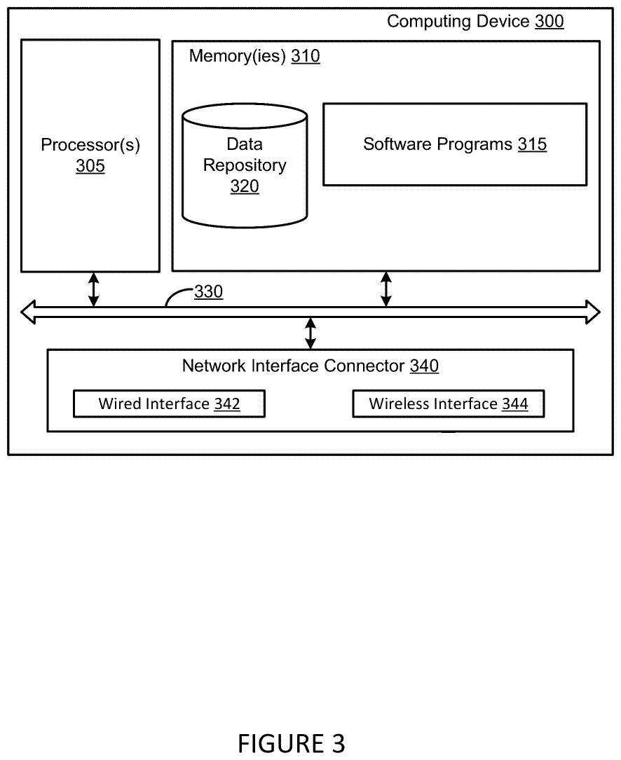

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Although several embodiments have been disclosed, it should be recognized that these embodiments are not exclusive to each other, and features from one embodiment may be used with others.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method comprising:
ingesting, by a credit classification computer program executed by an electronic device, historical data for prior credit applications;
separating, by the credit classification computer program, the historical data into a plurality of categories;
encrypting, by the credit classification computer program, the historical data in each category;
training, by the credit classification computer program, a machine learning model for each category with the encrypted historical data for that category;
receiving, by the credit classification computer program and from a credit applicant computer program, credit applicant information;
separating, by the credit classification computer program, the credit applicant information into the plurality of categories;
predicting, by the credit classification computer program and using the plurality of machine learning models for each category, a credit classification using the credit application information for that category;
aggregating, by the credit classification computer program, the plurality of credit classifications into a final credit classification; and
outputting, by the credit classification computer program, the final credit classification to a downstream system, wherein the downstream system is configured to execute an action in response to the final credit classification.

2. The method of claim 1, wherein the plurality of categories comprise a plurality of income, expenses, age, employment status, employment years, employment type, home ownership status home location, marital status, family status, liability information, and asset ownership.

3. The method of claim 1, wherein the historical data in each category is encrypted using homomorphic encryption.

4. The method of claim 1, wherein the plurality of credit classifications and the final credit classification are selected from the group consisting of fair, good, very good, and excellent.

5. The method of claim 1, wherein the step of aggregating, by the credit classification computer program, the plurality of credit classifications into the final credit classification comprises:
assigning, by the credit classification program, a weight to each of the plurality of credit classifications; and
combining, by the credit classification computer program, the plurality of credit classifications according to their weights.

6. The method of claim 5, wherein the weights are predicted using a second machine learning model.

7. The method of claim 1, further comprising:
encrypting, by the credit classification computer program, the credit application in each category using homomorphic encryption.

8. A system, comprising:
a database comprising historical data for prior credit applications;
an electronic device executing a credit classification computer program;
a user electronic device executing a credit applicant computer program; and
a downstream system;
wherein:
the credit classification computer program ingests the historical data for prior credit applications;
the credit classification computer program separates the historical data into a plurality of categories;
the credit classification computer program encrypts the historical data in each category;
the credit classification computer program trains a machine learning model for each category with the encrypted historical data for that category;
the credit classification computer program receives credit applicant information from the credit applicant computer program;
the credit classification computer program separates the credit applicant information into the plurality of categories;
the credit classification computer program predicts, using the plurality of machine learning models for each category, a credit classification using the credit application information for that category;
the credit classification computer program aggregates the plurality of credit classifications into a final credit classification;
the credit classification computer program outputs the final credit classification to the downstream system; and
the downstream system executes an action in response to the final credit classification.

9. The system of claim 8, wherein the plurality of categories comprise a plurality of income, expenses, age, employment status, employment years, employment type, home ownership status home location, marital status, family status, liability information, and asset ownership.

10. The system of claim 8, wherein the historical data in each category is encrypted using homomorphic encryption.

11. The system of claim 8, wherein the plurality of credit classifications and the final credit classification are selected from the group consisting of fair, good, very good, and excellent.

12. The system of claim 8, wherein the credit classification computer program aggregates the plurality of credit classifications into a final credit classification by assigning a weight to each of the plurality of credit classifications;
and by combining the plurality of credit classifications according to their weights.

13. The system of claim 12, wherein the weights are predicted using a second machine learning model.

14. The system of claim 8, wherein the credit classification computer program encrypts the credit application in each category using homomorphic encryption.

15. A non-transitory computer readable storage medium, including instructions stored thereon, which when read and executed by one or more computer processors, cause the one or more computer processors to perform steps comprising:
ingesting historical data for prior credit applications;
separating the historical data into a plurality of categories;
encrypting the historical data in each category;
training a machine learning model for each category with the encrypted historical data for that category;
receiving, from a credit applicant computer program, credit applicant information;
separating the credit applicant information into the plurality of categories;
predicting, and using the plurality of machine learning models for each category, a credit classification using the credit application information for that category;
aggregating the plurality of credit classifications into a final credit classification; and
outputting the final credit classification to a downstream system.

16. The non-transitory computer readable storage medium of claim 15, wherein the plurality of categories comprise a plurality of income, expenses, age, employment status, employment years, employment type, home ownership status home location, marital status, family status, liability information, and asset ownership.

17. The non-transitory computer readable storage medium of claim 15, wherein the historical data in each category is encrypted using homomorphic encryption.

18. The non-transitory computer readable storage medium of claim 15, wherein the plurality of credit classifications and the final credit classification are selected from the group consisting of fair, good, very good, and excellent.

19. The non-transitory computer readable storage medium of claim 15, aggregating the plurality of credit classifications into the final credit classification comprises:
assigning a weight to each of the plurality of credit classifications; and
combining the plurality of credit classifications according to their weights;
wherein the weights are predicted using a second machine learning model.

20. The non-transitory computer readable storage medium of claim 15, further including instructions stored thereon, which when read and executed by one or more computer processors, cause the one or more computer processors to perform steps comprising:
encrypting the credit application in each category using homomorphic encryption.
